(19) United States
(12) Patent Application Publication
(10) Pub. No.: US 2014/0061110 A1
(43) Pub. Date: Mar. 6, 2014

(54) FILTER HOUSING WITH INTEGRALLY THREADED PORT

(71) Applicants: Charles W. HAWKINS, Sparta, TN (US); Wilson Lee CURRIER, Cookeville, TN (US); Ismail C. BAGCI, Cookeville, TN (US); Johnny D. BRYANT, Walling, TN (US); Gildas LE MEN, Guengat (FR)

(72) Inventors: Charles W. HAWKINS, Sparta, TN (US); Wilson Lee CURRIER, Cookeville, TN (US); Ismail C. BAGCI, Cookeville, TN (US); Johnny D. BRYANT, Walling, TN (US); Gildas LE MEN, Guengat (FR)

(73) Assignee: CUMMINS FILTRATION IP, INC., Minneapolis, MN (US)

(21) Appl. No.: 13/598,975

(22) Filed: Aug. 30, 2012

(51) Int. Cl. B01D 35/34

(52) U.S. Cl. 210/232; 210/435

(57) ABSTRACT

A filter housing that includes a bowl formed with a single thread that is stamped directly into the housing around a port. The thread is used to connect an auxiliary element, such as a drain valve or a WIF sensor, to the filter housing. An elevated ridge is formed around the bowl during the stamping process which increases the structural integrity of the housing around the port, and provides a surface for mating with the inserted auxiliary element.

### FIELD

A filter housing and a filter assembly that uses the filter housing are described, where the filter housing includes an integrally formed thread on a drain or sensor port.

### BACKGROUND

In current filters, auxiliary elements such as water-in-fuel (WIF) sensors and/or drain valves are connected to the filter housing via a crimp nut. The crimp nut is placed in a port in the filter housing, sealant is applied, and the crimp nut is crimped to secure the crimp nut to the filter housing. The auxiliary element is then threaded into the crimp nut, with sealing provided between the auxiliary element and the crimp nut to prevent fluid leaks. However, fluid leakage can occur at the crimp nut seam. In addition, the crimp nut adds additional cost and it requires a separate threaded component attached by an additional process.

FR2880562 discloses a filter housing that eliminates the crimp nut and instead uses an integrally formed thread to secure a draining/purging valve.

### SUMMARY

An improved filter housing is described that includes a single thread which is stamped directly into the housing around a port to connect an auxiliary element to the filter housing. Auxiliary elements that can be used depend upon the specific application of the filter and filter housing, but can include, but are not limited to, drain-valves and WIF sensors.

The thread can be, for example, a one pitch thread that is formed around the port during a stamping operation on the housing which can be formed of metal. An elevated ridge is formed on the housing around the port during the stamping process which increases the structural integrity of the housing, provides a surface for mating with the inserted auxiliary element, and better allows a single formed thread to be applied to the housing.

In one embodiment, a filter housing suitable for housing a filter media includes a metal shell having a side wall and a bottom wall connected to the side wall, where the side wall and the bottom wall define an interior space for receiving the filter media. The side wall defines an open end of the filter housing, the bottom wall forms a closed end opposite the open end, and the open end is sized to permit introduction of the filter media into the interior space. A bowl is stamped into the bottom wall or the side wall with the bowl including a port therethrough that places the interior space in communication with an exterior of the filter housing. An integrally formed thread is formed around at least a portion of the port for threaded connection with threads on an auxiliary element for connecting the auxiliary element to the filter housing.

In addition, the bowl includes a perimeter wall, which in one embodiment can define a seal support surface that extends circumferentially about the perimeter wall. A stamped ridge is integrally formed with the bottom wall or the side wall and that extends at a first end thereof from the perimeter wall and surrounds the bowl. The stamped ridge projects beyond a surface of the bottom wall or the side wall in a direction opposite the bowl to help increase the structural integrity of the bottom wall or the side wall of the housing.

In another embodiment, a filter assembly is provided that includes the filter housing described herein, a filter media disposed within the interior space of the filter housing, a nut plate attached to the side wall at the open end of the filter housing, an auxiliary element threaded into the port, and a seal disposed between the auxiliary element and the perimeter wall.

The filter assembly and filter media can be configured for any desired filtering application. One example of a filtering application includes, but is not limited to, a fuel filter assembly for filtering diesel fuel. However, the filter assembly can be used in other applications including, but not limited to, filtering oil, hydraulic fluid, or other applications.

The described filter housing and filter assembly eliminates the crimp nut and sealant used in some current designs. In addition, the stamped ridge on the filter housing increases the structural integrity of the housing so that the housing meets or exceeds current structural requirements of existing housings.

In one embodiment, the first end of the thread does not circumferentially overlap the second end of the thread so that a gap is formed therebetween. The gap enhances venting of air from the interior of the filter housing and the drain rate of fluid (when the auxiliary element is a valve) during use.

### DRAWINGS

FIG. 1 illustrates a filter assembly employing a filter housing described herein.

FIG. 2 is a cross-sectional view through a portion of the bottom wall of FIG. 1 showing details of the stamped bowl.

FIG. 3 is a perspective view of a portion of the bottom wall of the filter housing of FIG. 1.

FIG. 4 is a cross-sectional view of the stamped bowl in the bottom wall of the filter housing, with the auxiliary element removed.

FIG. 5 is a cross-sectional view of another embodiment of a filter housing with a domed bottom wall.

FIG. 6 is a cross-sectional view of another embodiment of a stamped bowl.

### DETAILED DESCRIPTION

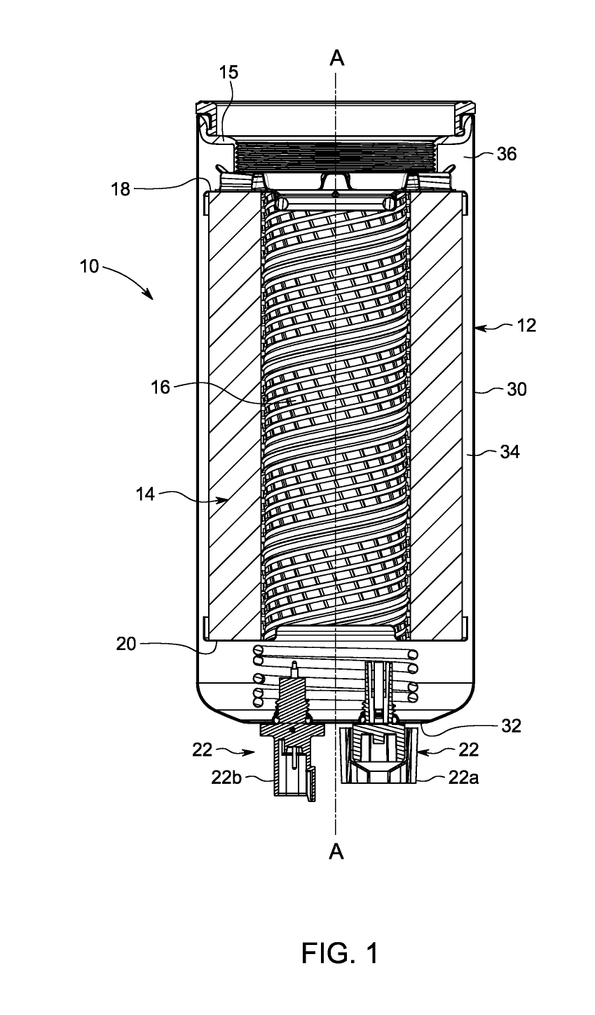

With reference to FIG. 1, a filter assembly 10 is illustrated that includes a filter housing 12, a filter media 14 disposed within the filter housing, and a nut plate 15 that is fixed to the open end of the filter housing. The filter assembly 10 illustrated in FIG. 1 is configured as a fuel filter assembly for filtering diesel fuel. However, the filter assembly 10 can be configured for any desired filtering application. Examples of other filtering applications include, but are not limited to, an oil filter assembly for filtering oil, a hydraulic filter assembly for filtering hydraulic fluid, and other applications.

In addition, the filter assembly 10 illustrated in FIG. 1 is configured to be disposable. However, in other embodiments, the filter assembly can be configured to allow replacement of the filter media 14 in which case the housing 12 would be reused and a detachable lid would be connected to the end of the filter housing (instead of the nut plate 15) to allow access to the filter media 14 for removal and replacement of the filter media.

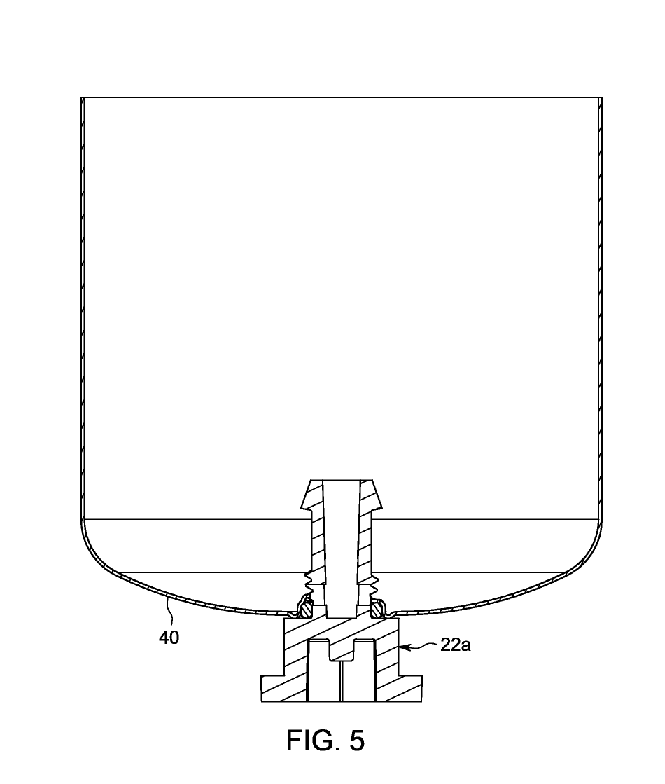

One or more auxiliary elements 22 are attached to the bottom of the filter housing 12. The auxiliary element(s) perform functions based on the particular application of the filter assembly. In the illustrated embodiment, two auxiliary elements 22a, 22b are attached to the filter housing. But as illustrated in FIG. 5, a single auxiliary element 22a can be attached to the housing. The functions of the auxiliary element(s) include, but are not limited to, sensing a condition within the filter housing 12 and/or draining fluid from the filter housing.

In the illustrated example, the filter media 14 is configured as a fuel-water separator media that is configured to separate water from fuel. Fuel-water separator media is well known in the art. The media 14 is generally ring-shaped defining a central cavity 16, with a first or upper endplate 18 attached to the upper end of the media 14 and a second or bottom endplate 20 attached to the lower end of the media 14. This configuration of the media is also well known in the art.

Water that is separated from the fuel by the media 14 collects at the base of the housing 12 and needs to be drained from the housing 12. In this case, the auxiliary element 22a comprises a drain valve, for example a manual drain valve, which is configured to drain water from the filter housing. The auxiliary element 22b is a WIF sensor that is configured to sense accumulation of water within the filter housing and to generate a warning signal when enough water accumulates.

The filter housing 12 is formed by a metal shell having a side wall 30 and a bottom wall 32 connected to the side wall. The side wall 30 and the bottom wall 32 define an interior space 34 that is use receives the filter media 14. The side wall defines an open end 36 of the filter housing, and the nut plate 15 is attached to the open end 36, while the bottom wall 32 forms a closed end opposite the open end. The open end 36 is sized to permit introduction/removal of the filter media 14 into the interior space 34 during assembly, after which the nut plate 15 is attached. The bottom wall 32 in FIG. 1 is illustrated as being generally flat. However, as illustrated in FIG. 5, the filter housing can use a dome-shaped bottom wall 40 as well.

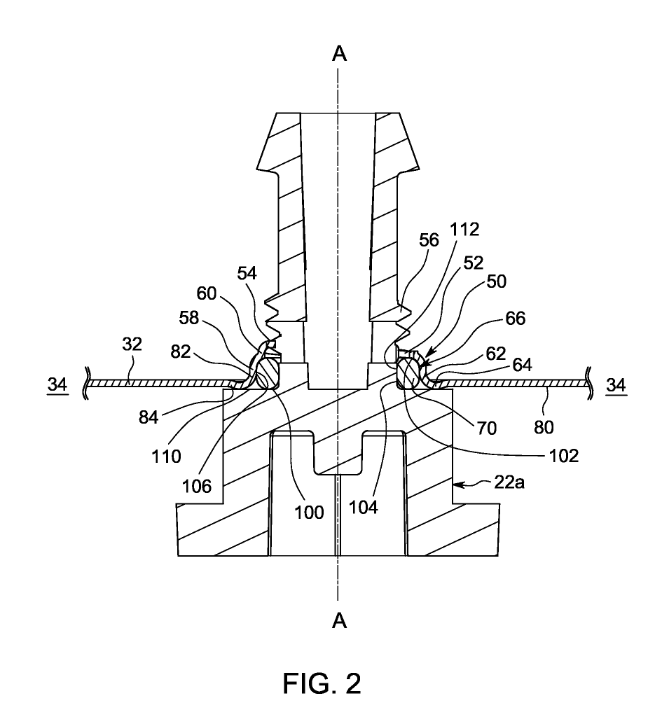

With reference to FIGS. 2-4, the mounting of the auxiliary elements 22a, 22b to the filter housing 12 will now be described. The auxiliary elements are illustrated as being mounted to the bottom wall 32. However, in some embodiments, one or more of the auxiliary elements can be mounted to the side wall 30 in which case the auxiliary element(s) would be mounted in the same manner as discussed below. In addition, the auxiliary elements 22a, 22b are mounted in the same manner, so only the mounting of the auxiliary element 22a will be discussed in detail below.

As shown in FIGS. 2-4, a bowl 50 is stamped into the bottom wall 32. The bowl 50 projects or extends in a direction into the interior space 34 of the housing 12. However, in some embodiments, the bowl 50 can project or extend in a direction away from the interior space so that the bowl 50 is disposed outside of the interior space of the housing.

The bowl 50 includes a port 52 therethrough that places the interior space 34 in communication with the exterior of the filter housing. In the illustrated embodiment, the port 52 has an axis that is parallel to a longitudinal axis A-A of the filter housing 12. However, the axis of the port can be at any angle to the longitudinal axis, including perpendicular when the auxiliary element is mounted to the side wall of the housing.

A thread 54 is integrally formed on the bowl 50 around at least a portion of the port 52 for threaded connection with threads 56 on the auxiliary element 22a for detachably connecting the auxiliary element 22a to the bottom wall 32. The thread 54 can be a one pitch thread that is created at the same time as the bowl 50 in a stamping operation to form the bowl.

The bowl 50 further includes a circumferentially extending perimeter wall 58 that has a first end 60 connected to the thread 54 and a second end 62 that is connected to a stamped ridge 64 that can also be created in the same stamping operation as the bowl. The perimeter wall 58 includes a seal support surface 66 that extends circumferentially about the perimeter wall. As best seen in FIGS. 2 and 4, the seal support surface 66 is axially spaced from the integrally formed thread 54 in the direction of the longitudinal axis and is disposed between the integrally formed thread 54 and the stamped ridge 64. As shown in FIG. 4, the seal support surface 66 has a portion 68 that extends in a radial direction perpendicular to the longitudinal axis A-A to support an end of a seal 70 and prevent the seal from interfering with the threads 54, 56.

The stamped ridge 64 is integrally formed with the bottom wall 32 and increases the structural integrity of the bottom wall around the bowl 50. The ridge 64 projects beyond an outer surface 80 of the bottom wall 32 in a direction opposite the bowl 50 (in the illustrated embodiment, the ridge 64 projects in a direction away from the interior space 34), and surrounds the bowl.

The ridge 64 includes a first end 82 thereof that is connected to and extends from the end 62 of the perimeter wall, and a second end 84 that connects to the remainder of the bottom wall 32. With reference to FIG. 4, a horizontal plane B-B that extends through where the first end 82 of the ridge 64 connects to the end 62 and through where the second end 84 connects to the remainder of the bottom wall, and that is perpendicular to the longitudinal axis A-A, does not extend through the perimeter wall 58.

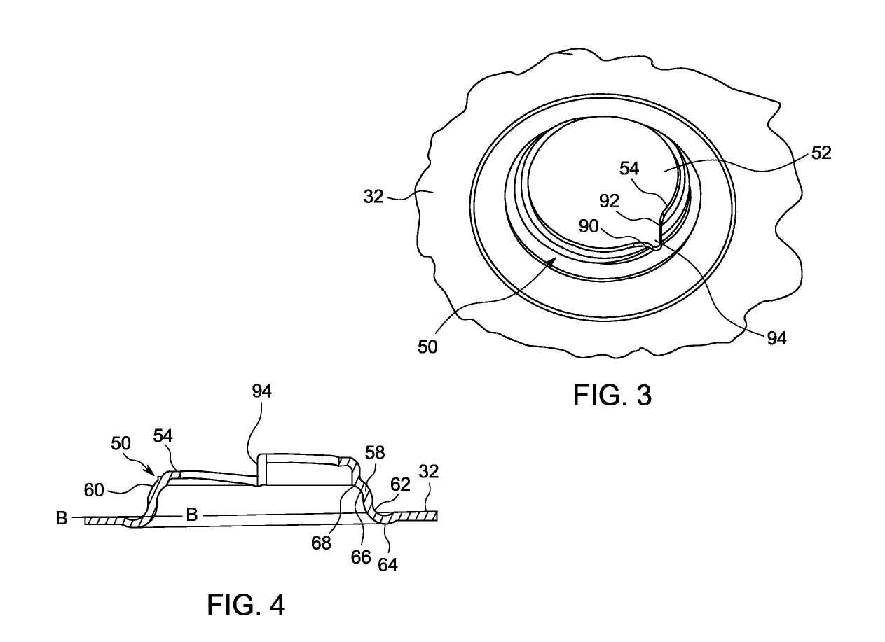

With reference to FIGS. 3 and 4, the thread 54 has a first terminal end 90 and a second terminal end 92. The first and second ends 90, 92 do not circumferentially overlap which creates a gap 94 between the ends 90, 92. The gap 94 enhances venting of air from the interior of the filter housing 12 and the drain rate of fluid (when the auxiliary element is a valve) during use. This gap 94 need not be formed when the auxiliary element is a WIF sensor.

Turning to FIG. 2, the seal 70 is illustrated as being an o-ring seal having a generally pill-shaped cross-section. The filter housing 12 and the auxiliary element 22a can be configured such that the seal 70 forms face seals 100, 102 with the auxiliary element and the perimeter wall, and the seal 70 forms radial seals 104, 106 with the auxiliary element and the perimeter wall 58. In particular, the seal 70 has a first portion engaged with and supported by the radial portion 68 of the seal support surface 66 to form the face seal 102, and a second portion in sealing engagement with a radially extending portion 110 of the auxiliary element 22a to form the face seal 100. In addition, the seal 70 has a portion engaged with an axially extending, radially outward facing surface 112 of the auxiliary element to form the radial seal 104, and a portion engaged with the interior, radially inward facing surface of the perimeter wall 58 to form the radial seal 106. However, the filter housing, the auxiliary element and/or the seal can have any configurations that are suitable for achieving these various seals.

As also illustrated in FIG. 2, the radially extending portion 110 of the auxiliary element 22a abuts against the stamped ridge 64 when fully installed. This helps to form a stop for the auxiliary element to limit insertion of the auxiliary element.

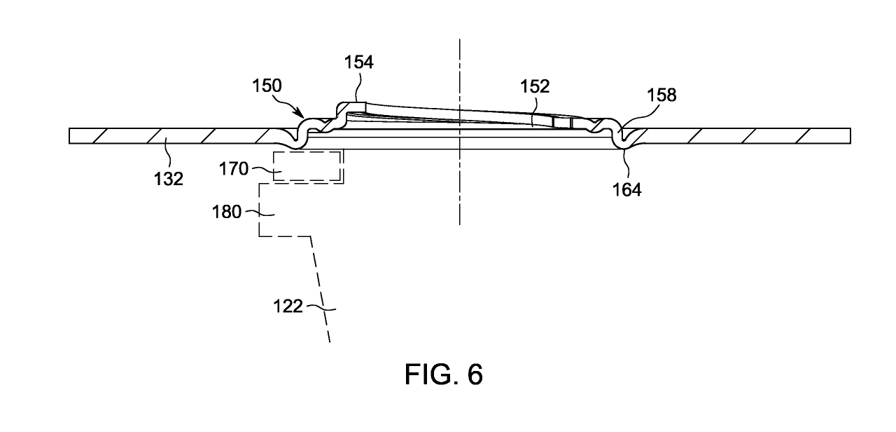

FIG. 6 illustrates another embodiment of a bowl 150 that is stamped into a bottom wall 132 of a filter housing. The bowl 150 is similar to the bowl 50 in that the bowl 150 includes a port 152, an integrally formed thread 154, a perimeter wall 158, and a stamped ridge 164 that increases the structural integrity of the bottom wall around the bowl 150.

In this embodiment, the bowl 150 does not project into the interior space of the housing as much as the bowl 50. Instead, this embodiment relies on a gasket seal 170 that is pressed into engagement with the stamped ridge 164 by a radially extending portion 180 of an auxiliary element 122 (only a portion of which is shown in FIG. 6) that is threaded into the port 152.

The invention may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A filter housing suitable for housing a filter media, comprising:
a metal shell having a side wall and a bottom wall connected to the side wall, the side wall and the bottom wall defining an interior space for receiving the filter media, the side wall defining an open end of the filter housing, the bottom wall forming a closed end opposite the open end, and the open end being sized to permit introduction of the filter media into the interior space;
a bowl stamped into the bottom wall or the side wall, the bowl including a port therethrough that places the interior space in communication with an exterior of the filter housing, an integrally formed thread around at least a portion of the port for threaded connection with threads on an auxiliary element for connecting the auxiliary element to the filter housing, and a perimeter wall; and
a stamped ridge integrally formed with the bottom wall or the side wall in which the bowl is formed, the stamped ridge extends at a first end thereof from the perimeter wall and surrounds the bowl, the stamped ridge projects beyond a surface of the bottom wall or the side wall in a direction opposite the bowl.

2. The filter housing of claim 1, wherein the bowl is formed in the bottom wall and the bowl projects into the interior space of the metal shell, and the stamped ridge projects in a direction away from the interior space.

3. The filter housing of claim 2, wherein the metal shell includes a longitudinal axis, the port has an axis that is parallel to the longitudinal axis, the perimeter wall defines a seal support surface that extends circumferentially about the perimeter wall, and the seal support surface is axially spaced from the integrally formed thread in the direction of the longitudinal axis and is disposed between the integrally formed thread and the stamped ridge.

4. The filter housing of claim 3, wherein the seal support surface has a portion that extends in a radial direction perpendicular to the longitudinal axis to support an end of a seal.

5. The filter housing of claim 1, wherein the integrally formed thread is a one pitch thread having a first end and a second end, and the first end of the thread does not circumferentially overlap the second end of the thread so that a gap is formed therebetween.

6. The filter housing of claim 2, wherein the bottom wall is flat or dome-shaped.

7. A filter assembly, comprising:
a filter housing that includes:
a metal shell having a side wall and a bottom wall connected to the side wall, the side wall and the bottom wall defining an interior space for receiving filter media, the side wall defining an open end of the filter housing, the bottom wall forming a closed end opposite the open end, and the open end being sized to permit introduction of the filter media into the interior space;
a bowl stamped into the bottom wall or the side wall, the bowl including a port therethrough that places the interior space in communication with an exterior of the filter housing, an integrally formed thread around at least a portion of the port for threaded connection with threads on an auxiliary element for connecting the auxiliary element to the filter housing, and a perimeter wall; and
a stamped ridge integrally formed with the bottom wall or the side wall in which the bowl is formed, the stamped ridge extends at a first end thereof from the perimeter wall and surrounds the bowl, the stamped ridge projects beyond a surface of the bottom wall or the side wall in a direction opposite the bowl;
a filter media disposed within the interior space;
an auxiliary element threaded into the port; and
a seal disposed between the auxiliary element and the perimeter wall.

8. The filter assembly of claim 7, wherein the bowl is formed in the bottom wall and the bowl projects into the interior space of the metal shell, and the stamped ridge projects in a direction away from the interior space.

9. The filter assembly of claim 8, wherein the metal shell includes a longitudinal axis, the port has an axis that is parallel to the longitudinal axis, the perimeter wall defines a seal support surface that extends circumferentially about the perimeter wall, and the seal support surface is axially spaced from the integrally formed thread in the direction of the longitudinal axis and is disposed between the integrally formed thread and the stamped ridge.

10. The filter assembly of claim 9, wherein the seal support surface has a portion that extends in a radial direction perpendicular to the longitudinal axis to support an end of the seal.

11. The filter assembly of claim 7, wherein the integrally formed thread is a one pitch thread having a first end and a second end, and the first end of the thread does not circumferentially overlap the second end of the thread so that a gap is formed therebetween.

12. The filter assembly of claim 8, wherein the auxiliary element comprises a water-in-fuel sensor or a drain valve, the auxiliary element includes a radially extending portion that abuts against the stamped ridge, and the seal has a first portion engaged with and supported by the seal support surface and a second portion in sealing engagement with the radially extending portion.

13. The filter assembly of claim 8, wherein the bottom wall is flat or dome-shaped.

14. The filter assembly of claim 7, wherein the seal forms face seals with the auxiliary element and the perimeter wall, and the seal forms radial seals with the auxiliary element and the perimeter wall.

15. The filter assembly of claim 12, wherein the filter assembly is a fuel filter assembly.
